(19) United States
(12) Patent Application Publication
(10) Pub. No.: US 2025/0210222 A1
(43) Pub. Date: Jun. 26, 2025

(54) WIRE HARNESS ASSEMBLY

(71) Applicant: Yazaki Corporation, Tokyo (JP)

(72) Inventors: Ryo HAMADA, Shizuoka (JP); Yukio NISHIO, Shizuoka (JP)

(73) Assignee: Yazaki Corporation, Tokyo (JP)

(21) Appl. No.: 18/976,615

(22) Filed: Dec. 11, 2024

(30) Foreign Application Priority Data
Dec. 20, 2023 (JP) 2023-215001

(51) Int. Cl. H01B 7/00

(52) U.S. Cl. CPC H01B 7/0045

(57) ABSTRACT

A wire harness assembly includes: a wire harness including an electric wire and a connector electrically connected to an end of the electric wire; and an assembly member in which the wire harness is arranged. The assembly member includes: a base; and a cover attached to the base via a bonding portion. The bonding portion includes a wayside bonding portion arranged along the electric wire. A non-bonding region in which the bonding portion is not arranged is provided between the base and the cover.

### CROSS-REFERENCE TO RELATED APPLICATIONS

The present application is based on and claims the benefit of priority from the prior Japanese Patent Application No. 2023-215001, filed on Dec. 20, 2023, the entire contents of which are incorporated by reference herein.

### TECHNICAL FIELD

The disclosure relates to a wire harness assembly.

### BACKGROUND

JP 2015-67071 A describes a wire harness assembly including a wire harness and an assembly sheet as an assembly member in which the wire harness is arranged, the wire harness including an electric wire and a connector electrically connected to an end of the electric wire. In the wire harness assembly, the assembly sheet includes a soundproofing/heat insulating sheet as a base and a bonding sheet as a cover. The wire harness is arranged between the soundproofing/heat insulating sheet and the bonding sheet. In the wire harness assembly, an adhesive is applied onto an entire surface of the bonding sheet to form a bonding portion, and the bonding sheet is attached to the soundproofing/heat insulating sheet via the bonding portion.

### SUMMARY

In the wire harness assembly described above, since the bonding portion for attaching the cover to the base is provided on the entire surface of the assembly member, a large amount of adhesive is used for the bonding portion, incurring a high cost.

The disclosure is directed to a wire harness assembly that can be manufactured at low cost.

A wire harness assembly in accordance with some embodiments includes: a wire harness including an electric wire and a connector electrically connected to an end of the electric wire; and an assembly member in which the wire harness is arranged. The assembly member includes: a base; and a cover attached to the base via a bonding portion. The bonding portion includes a wayside bonding portion arranged along the electric wire. A non-bonding region in which the bonding portion is not arranged is provided between the base and the cover.

According to the above-described configuration, the cost of the wire harness assembly can be reduced.

### BRIEF DESCRIPTION OF THE DRAWINGS

FIG. 1 is a perspective view of a wire harness assembly according to a first embodiment.

FIG. 2 is a top view of the wire harness assembly according to the first embodiment.

FIG. 3 is a perspective view of a wire harness assembly according to a second embodiment.

FIG. 4 is an enlarged perspective view of an extension of the wire harness assembly according to the second embodiment.

FIG. 5 is an enlarged top view of the extension of the wire harness assembly according to the second embodiment.

FIG. 6 is an enlarged perspective view of the extension of the wire harness assembly when divided by a dividing portion according to the second embodiment.

FIG. 7 is an enlarged top view of the extension of the wire harness assembly when divided by the dividing portion according to the second embodiment.

### DETAILED DESCRIPTION

Hereinafter, a wire harness assembly 1 according to an embodiment will be described in detail with reference to the drawings. Note that dimensional ratios in the drawings are exaggerated for convenience of explanation, and may be different from actual ratios.

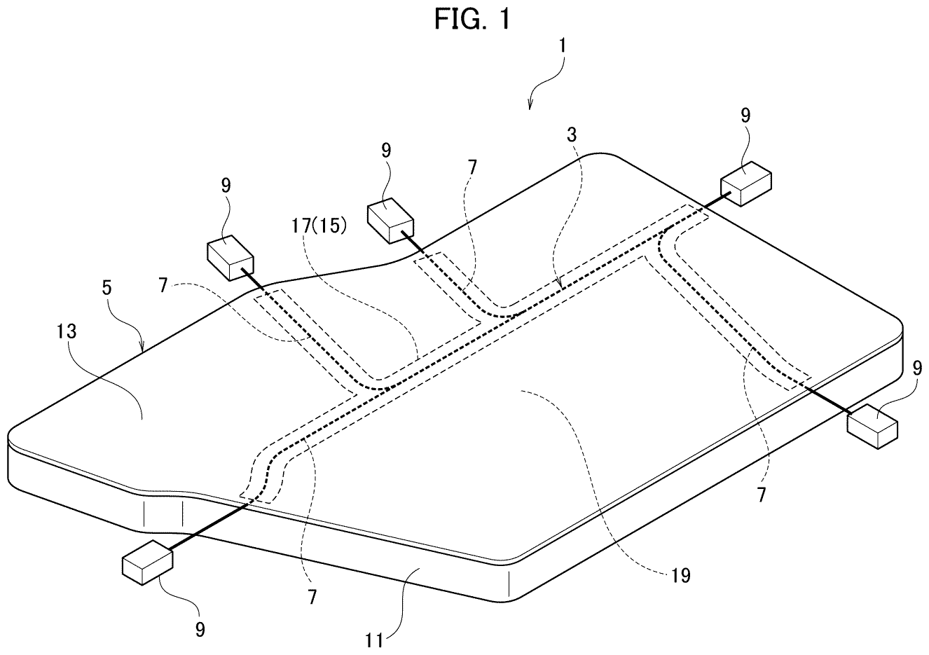

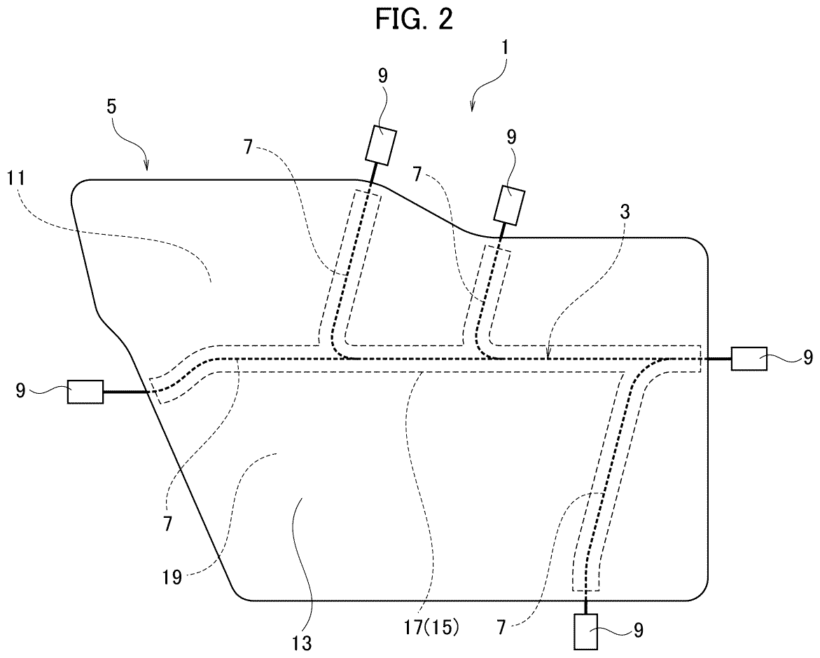

A first embodiment will be described with reference to FIGS. 1 and 2.

As illustrated in FIG. 1, the wire harness assembly 1 according to the first embodiment is applied to, for example, a wire harness 3 that electrically connects electrical components (not illustrated), e.g., a power supply mounted on a vehicle and a device or a device and a device. The wire harness 3 is arranged in a predetermined shape inside an assembly member 5 integrally assembled therewith. The wire harness assembly 1 is assembled to a target member (not illustrated), e.g., a door trim of a vehicle.

As illustrated in FIGS. 1 and 2, the wire harness assembly 1 includes a wire harness 3 and an assembly member 5.

As illustrated in FIGS. 1 and 2, the wire harness 3 includes an electric wire 7 and a connector 9.

The electric wire 7 includes, for example, a sheathed electric wire in which an outer periphery of a core wire made of a conductive material is sheathed with an insulating sheath, and a plurality of (four in the present embodiment) electric wires 7 are used. The electric wire 7 may be a flat cable in which outer peripheries of a plurality of core wires are sheathed with an insulating sheath in a state where the plurality of core wires are arranged in parallel. The plurality of electric wires 7 are arranged in such a manner that ends on both sides thereof are exposed from the assembly member 5. The plurality of electric wires 7 are arranged in such a manner that the ends on one end sides are collected at one location, and the ends on the other end sides are branched.

The connector 9 includes, for example, a housing (not illustrated) made of an insulating material such as a synthetic resin, and a terminal (not illustrated) made of a conductive material. The housing can be fitted to, for example, a mating housing (not illustrated) of a mating connector (not illustrated) electrically connected to an electric component mounted on the vehicle. The terminal is electrically connected to the end of the electric wire 7, and is accommodated in the housing. The terminal is electrically connected to a mating terminal (not illustrated) accommodated in the mating housing by fitting the housing to the mating housing. A plurality of (five in the present embodiment) connectors 9 are used to correspond to the ends of the plurality of electric wires 7 exposed from the assembly member 5.

As illustrated in FIGS. 1 and 2, the assembly member 5 includes a base 11 and a cover 13.

The base 11 is made of, for example, a foam of urethane or the like, or a nonwoven fabric of polypropylene fibers, polyethylene terephthalate fibers, polyester-based fibers, or the like, and has soundproofing and heat insulating properties. The base 11 is formed in a sheet shape with a size set so that the base 11 is arranged within the range of the target member, and is assembled to the target member by a fixing means (not illustrated) such as press fitting. On one surface side of the base 11, the plurality of (four in the present embodiment) electric wires 7 of the wire harness 3 are arranged in a predetermined shape. The ends of the plurality of electric wires 7, each of the electric wires 7 being arranged on the base 11, are exposed from an outer edge of the base 11 with a predetermined length, and the connectors 9 are arranged outside the base 11.

The cover 13 is made of, for example, a film of vinyl chloride, polyethylene, or the like, or a closed-cell foam or an open-cell foam of polyethylene, polypropylene, polystyrene, elastomer, or the like, and has soundproofing and heat insulating properties. The cover 13 is formed in a sheet shape with a size set to be equal to that of the base 11 so that the cover 13 is arranged within the range of the target member, and a thickness set to be smaller than that of the base 11. A bonding portion 15 formed of an adhesive is provided on a surface of the cover 13 facing the base 11. The cover 13 is attached to one surface side of the base 11 by the bonding portion 15 in such a manner that the plurality of electric wires 7 are sandwiched between the cover 13 and the base 11. In a state where the cover 13 is attached to the base 11, the plurality of electric wires 7 arranged in a predetermined shape are held between the base 11 and the cover 13. Therefore, the assembly member 5 can protect the electric wire 7 of the wire harness 3, and maintain the arrangement shape of the electric wire 7.

The connector 9 exposed from the assembly member 5 is fitted to a mating connector in a state where the wire harness assembly 1 is assembled to the target member. At this time, since the electric wire 7 is exposed from the outer edge of the assembly member 5 with a predetermined length, the connector 9 can freely move, making it easy to fit the connector 9 to a mating connector. By fitting the connector 9 to the mating connector, electrical components are electrically connected to each other.

Here, in a conventional wire harness assembly, a bonding portion for attaching a base and a cover is provided on an entire surface of an assembly member. Therefore, a large amount of adhesive is used for the bonding portion, incurring a high cost.

On the other hand, in the present embodiment, the bonding portion 15 includes a wayside bonding portion 17. A non-bonding region 19 in which the bonding portion 15 is not arranged is provided between the base 11 and the cover 13.

The wayside bonding portion 17 is arranged along the electric wire 7 arranged inside the assembly member 5 between the base 11 and the cover 13 of the assembly member 5. The wayside bonding portion 17 is formed on the base 11, for example, by arranging a masking sheet (not illustrated) having the same shape as the base 11, with a through hole formed in a portion where the wayside bonding portion 17 is to be formed, on one surface side of the base 11 and spraying an adhesive. Note that the wayside bonding portion 17 may be formed on the cover 13. The wayside bonding portion 17 bonds portions of the base 11 and the cover 13 where the electric wire 7 is arranged to attach the base 11 and the cover 13 integrally. By providing the wayside bonding portion 17 in a portion of the assembly member 5 where the electric wire 7 is arranged, the base 11 and the cover 13 can be integrated, and a portion of the assembly member 5 where the electric wire 7 is not arranged can be a non-bonding region 19 where the bonding portion 15 is not arranged. Therefore, it is possible to reduce the adhesive usage amount as much as the non-bonding region 19 where the electric wire 7 of the assembly member 5 is not arranged. In addition, by arranging the wayside bonding portion 17 along the electric wire 7, the electric wire 7 arranged in the wayside bonding portion 17 can be bonded, and the arrangement shape of the electric wire 7 can be stably maintained. Furthermore, by arranging the wayside bonding portion 17 along the electric wire 7, the wayside bonding portion 17 can be used as a guide for arranging the electric wire 7, and assemblability can be improved.

The wire harness assembly 1 according to the present embodiment includes a wire harness 3 including a electric wire 7 and a connector 9 electrically connected to an end of the electric wire 7, and an assembly member 5 in which the wire harness 3 is arranged. The assembly member 5 includes a base 11, and a cover 13 attached to the base 11 via a bonding portion 15. The bonding portion 15 includes a wayside bonding portion 17 arranged along the electric wire 7. A non-bonding region 19 in which the bonding portion 15 is not arranged is provided between the base 11 and the cover 13.

By providing the wayside bonding portion 17 in the bonding portion 15, the base 11 and the cover 13 can be integrated, and a portion of the assembly member 5 where the electric wire 7 is not arranged can be a non-bonding region 19 where the bonding portion 15 is not arranged. Therefore, it is possible to reduce the adhesive usage amount as much as the non-bonding region 19 where the electric wire 7 of the assembly member 5 is not arranged. In addition, by arranging the wayside bonding portion 17 along the electric wire 7, the electric wire 7 arranged in the wayside bonding portion 17 can be bonded, and the arrangement shape of the electric wire 7 can be stably maintained. Furthermore, by arranging the wayside bonding portion 17 along the electric wire 7, the wayside bonding portion 17 can be used as a guide for arranging the electric wire 7, and assemblability can be improved.

As a result, the cost of the wire harness assembly 1 can be reduced.

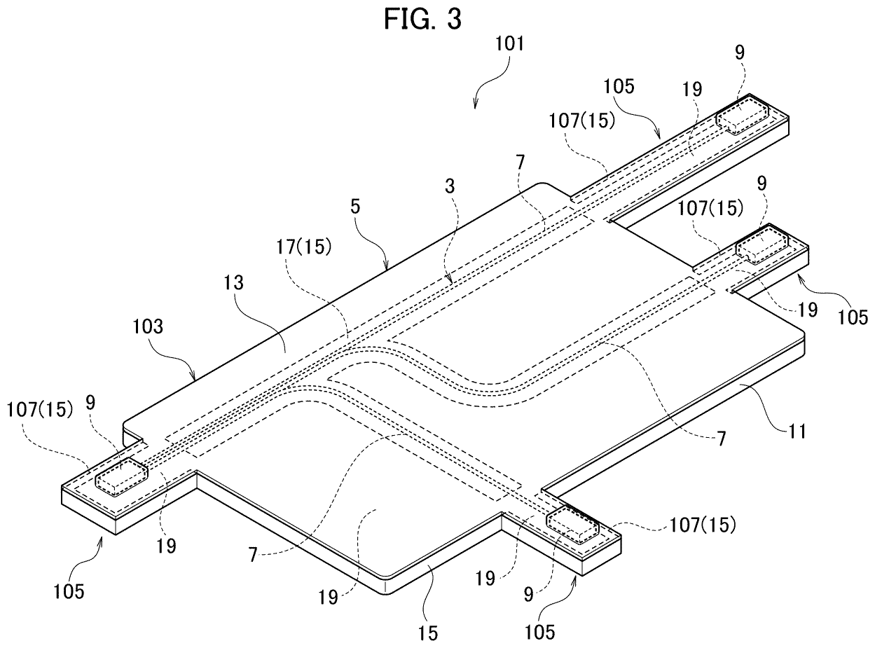

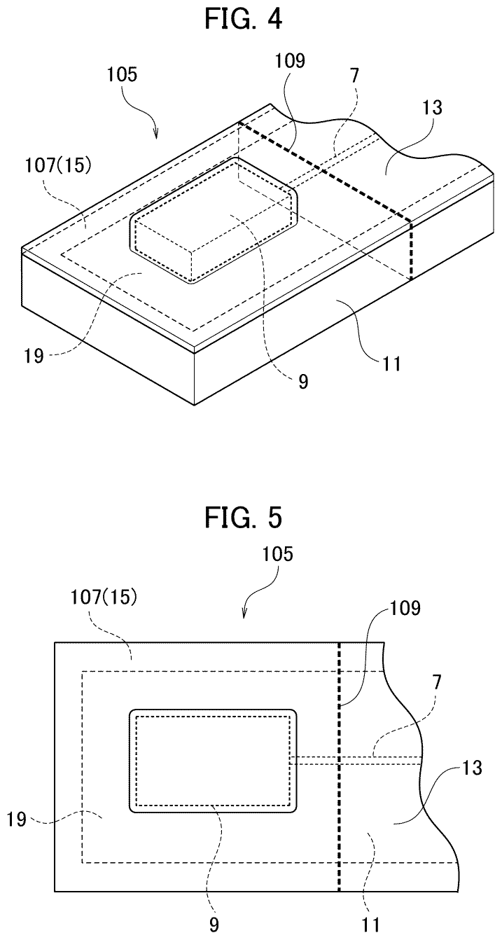

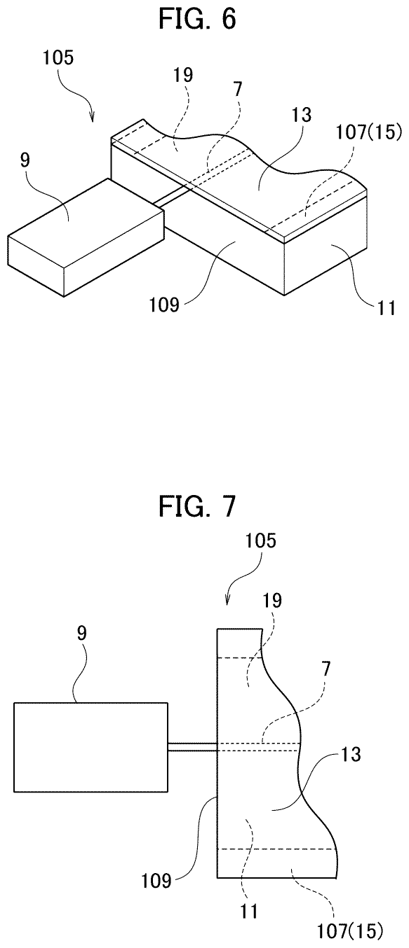

A second embodiment will be described with reference to FIGS. 3 to 7.

In a wire harness assembly 101 according to the second embodiment, the assembly member 5 includes a body 103 in which the electric wire 7 is arranged, and an extension 105 in which the connector 9 is arranged, the extension 105 being formed as a single member continuous with the body 103. The bonding portion 15 has an avoidance bonding portion 107 arranged at a position avoiding the connector 9 and the electric wire 7 in the extension 105.

The extension 105 has a dividing portion 109 capable of dividing the extension 105 to expose the connector 9.

Note that the same components as those of the first embodiment will be denoted by the same reference signs, and the description of functions thereof will be omitted because the first embodiment can be referred to. Also, the actions and effects obtained from the same components are equivalent.

In the present embodiment, as illustrated in FIG. 3, the wire harness 3 includes three electric wires 7 and four connectors 9. The wire harness 3 is arranged inside the assembly member 5.

As illustrated in FIGS. 3 to 7, the assembly member 5 includes a body 103 and an extension 105.

The body 103 is formed in, for example, a rectangular shape. In the body 103, a plurality of (three in the present embodiment) electric wires 7 are arranged in a predetermined shape between the base 11 and the cover 13. In the body 103, a wayside bonding portion 17 of the bonding portion 15 is arranged, and the base 11 and the cover 13 are integrally attached to each other. In addition, by arranging the wayside bonding portion 17 in the body 103, the arrangement shape of the electric wire 7 arranged in the body 103 can be stably maintained. In the body 103, a portion where the wayside bonding portion 17 is not arranged is a non-bonding region 19. Therefore, it is possible to reduce the adhesive usage amount as much as the non-bonding region 19 where the electric wire 7 is not arranged of the body 103.

The extension 105 is arranged with respect to the body 103 to correspond to each of the plurality of (four in the present embodiment) connectors 9. The extension 105 extends outward from an outer edge of the body 103 as a single member continuous with the body 103. In the extension 105, the end of the electric wire 7 and the connector 9 are arranged between the base 11 and the cover 13. Therefore, the end of the electric wire 7 and the connector 9 of the wire harness 3 can be protected by the extension 105. By providing the extension 105 in the assembly member 5, it is possible to prevent direct interference between the connector 9 and peripheral members, for example, when the wire harness assembly 101 is packaged or assembled to the target member. For example, when the wire harness assembly 101 is packaged, if the extension 105 protrudes from a packaging box, the extension 105 may be folded back toward the body 103. Even in such a state, the connector 9 is not exposed to the outside, and direct interference between the connector 9 and peripheral members can be prevented. For example, when the wire harness assembly 101 is assembled to the target member, the extension 105 is removed, and the end of the electric wire 7 and the connector 9 are exposed from the assembly member 5. The bonding portion 15 arranged in the extension 105 includes an avoidance bonding portion 107.

The avoidance bonding portion 107 is arranged along an outer edge of the extension 105 to avoid the end of the electric wire 7 and the connector 9 between the base 11 and the cover 13 in the extension 105. The avoidance bonding portion 107 is formed on the base 11, but may be formed on the cover 13. The avoidance bonding portion 107 bonds outer edges of the base 11 and the cover 13 to each other in the extension 105 to attach the base 11 and the cover 13 integrally. In the extension 105, a portion where the avoidance bonding portion 107 is not arranged is a non-bonding region 19. Therefore, it is possible to reduce the adhesive usage amount as much as the non-bonding region 19 where the end of the electric wire 7 and the connector 9 are arranged of the extension 105. Since the end of the electric wire 7 and the connector 9 are not arranged in the avoidance bonding portion 107, the adhesive of the avoidance bonding portion 107 does not adhere to the end of the electric wire 7 and the connector 9. Therefore, in a state where the connector 9 is exposed from the assembly member 5, the connector 9 can be easily fitted because the adhesive does not adhere to the connector 9. The extension 105, in which the avoidance bonding portion 107 is arranged, has a dividing portion 109.

The dividing portion 109 is formed, for example, by making cuts (notches) in the base 11 and the cover 13 positioned in the extension 105. The dividing portion 109 is arranged in the extension 105 at a position where the end of the electric wire 7 is exposed with a predetermined length when the extension 105 is removed. By dividing the extension 105 with the dividing portion 109, the extension 105 can be easily removed, and the connector 9 can be easily exposed from the assembly member 5. Therefore, in order to expose the connector 9 from the assembly member 5, it is not necessary to cut the extension 105 with a jig or the like, and assemblability can be improved. In a case where the extension 105 does not protrude from the target member, the dividing portion 109 may be provided only in the cover 13. The dividing portion 109 provided in the cover 13 divides a portion of the cover 13 to be removed, in the extension 105, when the cover 13 is peeled off from the base 11. Therefore, when the connector 9 is exposed, it is not necessary to press or cut the cover 13 at a predetermined position with a jig or the like, and assemblability can be improved.

In the wire harness assembly 101 according to the present embodiment, the assembly member 5 includes a body 103 in which the electric wire 7 is arranged, and an extension 105 in which the connector 9 is arranged, the extension 105 being formed as a single member continuous with the body 103. The bonding portion 15 has an avoidance bonding portion 107 arranged at a position avoiding the connector 9 and the electric wire 7 in the extension 105.

By providing the extension 105 in the assembly member 5, the connector 9 can be protected. Therefore, it is possible to prevent direct interference between the connector 9 and peripheral members, for example, when the wire harness assembly 101 is packaged or assembled to the target member. In addition, in the extension 105, since the bonding portion 15 has the avoidance bonding portion 107 arranged at a position avoiding the connector 9 and the electric wire 7, a portion where the avoidance bonding portion 107 is not arranged can be a non-bonding region 19. Therefore, it is possible to reduce the adhesive usage amount as much as the non-bonding region 19 where the electric wire 7 and the connector 9 are arranged of the extension 105. Furthermore, since the electric wire 7 and the connector 9 are not arranged in the avoidance bonding portion 107, the adhesive of the avoidance bonding portion 107 does not adhere to the electric wire 7 and the connector 9. Therefore, in a state where the connector 9 is exposed from the assembly member 5, the connector 9 can be easily fitted because the adhesive does not adhere to the connector 9.

The extension 105 has a dividing portion 109 capable of dividing the extension 105 to expose the connector 9.

By dividing the extension 105 with the dividing portion 109, the extension 105 can be easily removed, and the connector 9 can be easily exposed from the assembly member 5. Therefore, in order to expose the connector 9 from the assembly member 5, it is not necessary to cut the extension 105 with a jig or the like, and assemblability can be improved.

In the above-described embodiments, the number of electric wires 7 in the wire harness 3 is three or four, but the present invention is not limited thereto, and the number of electric wires 7 may be two or less or may be five or more. In the above-described embodiments, one end sides of the plurality of electric wires 7 are collected into one connector 9, but the present invention is not limited thereto, and the connector 9 may be provided on each of one end sides of the plurality of electric wires 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wire harness assembly comprising:
a wire harness including an electric wire and a connector electrically connected to an end of the electric wire; and
an assembly member in which the wire harness is arranged, wherein
the assembly member includes:
a base; and
a cover attached to the base via a bonding portion,
the bonding portion includes a wayside bonding portion arranged along the electric wire, and
a non-bonding region in which the bonding portion is not arranged is provided between the base and the cover.

2. The wire harness assembly according to claim 1, wherein
the assembly member includes:
a body in which the electric wire is arranged; and
an extension in which the connector is arranged, the extension being formed as a single member continuous with the body, and
the bonding portion includes an avoidance bonding portion arranged at a position avoiding the connector and the electric wire in the extension.

3. The wire harness assembly according to claim 2, wherein the extension includes a dividing portion configured to divide the extension to expose the connector.
